(19) United States
(12) Patent Application Publication
(10) Pub. No.: US 2010/0087104 A1
(43) Pub. Date: Apr. 8, 2010

(54) Terminal crimp having knurl with omega-shaped cross-section

(76) Inventors: Bruce S. Gump, Warren, OH (US); Mark David Baranski, Warren, OH (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/286,767

(22) Filed: Oct. 2, 2008

(51) Int. Cl. H01R 4/10; H01R 43/04

(52) U.S. Cl. 439/877; 29/882

(57) ABSTRACT

A cable includes a terminal crimped onto the wire. The terminal defines a knurl having a first portion in contact with the wire and a second portion integrally formed with the first portion and in contact with the wire. The first portion is wider than the second portion. The terminal includes a material having a unitary configuration and configured to be crimped onto the wire. A plurality of knurls, each defining the first portion and the second portion, are integrally formed with the material, and the first portion is wider than the second portion. Moreover, a method includes deforming the terminal to have a substantially U-shaped knurl, wherein the U-shaped knurl has the first portion and the second portion, and deforming the second portion of the U-shaped knurl such that the first portion is wider than the second portion.

### BACKGROUND

Crimping terminals onto wires provides strong electrical and physical connections to the wire. However, various corrosion products that accumulate on the surface of the terminal and/or wire can impede the electrical connection and weaken the physical connection. This may be especially true if the wire and/or terminal are formed from aluminum or aluminum-based materials. Various methods are employed to overcome these impediments, but few are successful in high volume applications. Making an electrically stable contact with the wire for long periods of time and over many different environmental factors, generally includes breaking through the corrosion products to expose non-corroded portions of the wire, removing the corrosion products on the surface of the terminal, and electrically connecting the non-corroded portions of the wire and terminal to one another in a manner that will be physically stable over time, temperature, and other environmental changes. This is extremely difficult when the wire has traditional serration patterns in the crimp area of the terminal because the hardness of the aluminum is low and the corrosion products are often much harder and tenacious. In addition, the aluminum in the wire tends to extrude out of the ends of the terminal resulting in less contact force with the surface of the terminal. As a result, the wire does not maintain adequate contact with the terminal.

Accordingly, a terminal is needed that can provide a strong electrical and physical connection to the wire, even if the wire is formed from aluminum or an aluminum-based material.

### BRIEF SUMMARY

A cable includes a terminal crimped onto a wire. The terminal defines a knurl having a first portion in contact with the wire and a second portion integrally formed with the first portion and in contact with the wire. The first portion is wider than the second portion.

In addition, the terminal includes a material having a unitary configuration and configured to be crimped onto the wire, and a plurality of knurls integrally formed with the material, wherein each of the plurality of knurls defines the first portion and the second portion, wherein the first portion is wider than the second portion.

Moreover, a method includes deforming the terminal to have a substantially U-shaped knurl, wherein the U-shaped knurl has the first portion and the second portion, and deforming the second portion of the U-shaped knurl such that the first portion is wider than the second portion.

### BRIEF DESCRIPTION OF THE DRAWINGS

FIG. 1A is side view of a terminal having a material deformed to have a plurality of substantially U-shaped knurls having a first portion and a second portion, according to an embodiment;

FIG. 1B is a side view of the material after being deformed to have the U-shaped knurls, according to an embodiment;

FIG. 1C is a side view of the material being deformed to have a plurality of substantially V-shaped knurls about each of the U-shaped knurls to deform the second portions, according to an embodiment;

FIG. 1D is a side view of the material after being deformed to have the U-shaped knurls and the V-shaped knurls such that the terminal defines a plurality knurls wherein the first portion is wider than the second portion, according to an embodiment;

FIG. 2 is perspective view of a wire and the terminal configured to receive the wire, according to an embodiment;

FIG. 3 is a perspective view of the terminal crimped onto the wire, according to an embodiment; and

FIG. 4 is a perspective view of the terminal crimped onto the wire in a two-stage process, according to an embodiment.

### DETAILED DESCRIPTION

A cable includes a wire crimped to a terminal that defines a plurality of knurls having a first portion that is wider than a second portion. A method of forming each knurl includes deforming a terminal to have a substantially U-shaped knurl and deforming the second portion of the U-shaped knurl such that the first portion is wider than the second portion. This resulting knurl has a dovetail-type shaped cross-section in the crimp area of the terminal, similar to the shape of the upper case Greek letter omega (Ω). When the wire is forced into the omega-shaped knurl via the crimping operation pressure, it is held tightly against the terminal itself. In addition, surface oxides or other corrosion products on the wire are broken during crimping. Furthermore, the wire will not be able to move away from the terminal because of the knurl, which results in a highly stable electrical contact over time, temperature, and other environmental changes. Moreover, this method does not crush or reduce the cross-sectional area of the wire. Because the electrical and mechanical functions of the terminal are opposed to each other in a pressure contact, this method will enable both to occur in an operational range. In one exemplary approach, the cable, terminal, and method described herein may be used with aluminum or aluminum-based wires.

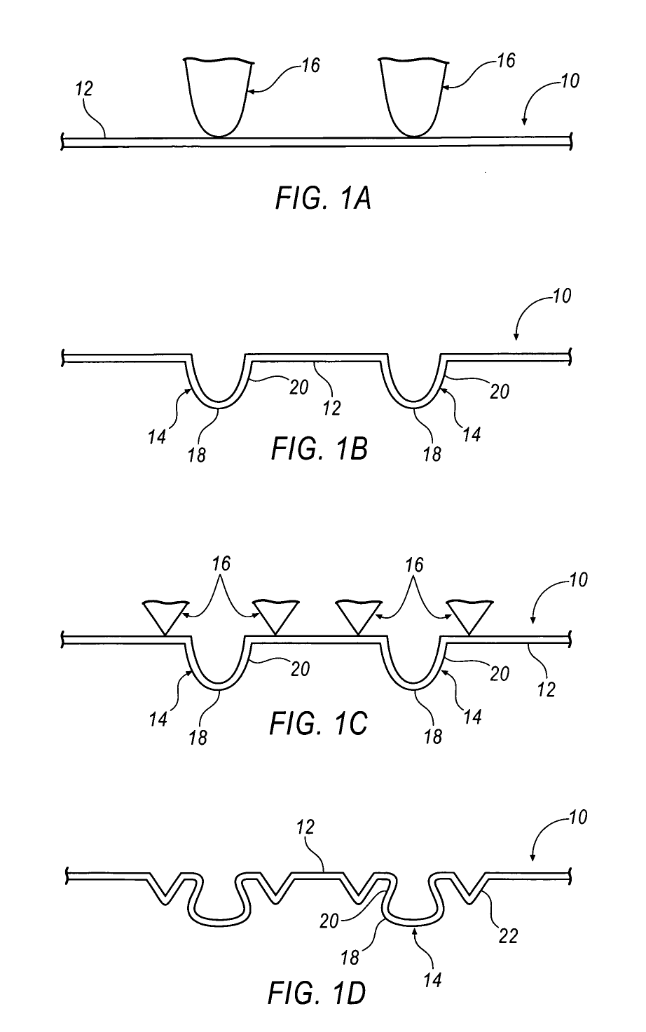

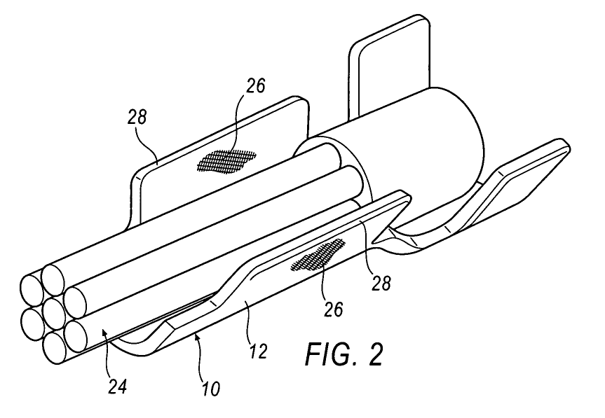

A method of forming a knurl pattern with an omega-shaped cross-section on a terminal 10 is illustrated with reference to FIGS. 1A-1D. The terminal 10 may be formed from a generally planar material 12, such as a metal, having a unitary configuration. In one exemplary approach, the knurl pattern is integrally formed with the material 12 of the terminal 10 in a two-stage process. First, as illustrated in FIG. 1A, the terminal is deformed to define a substantially U-shaped knurl 14. In one exemplary approach, the terminal 10, and specifically, the planar material 12, is deformed with a deforming tool 16. It is to be appreciated that deforming the material 12 may further be defined as punching, embossing, stamping, impressing, etc. Once deformed, as illustrated in FIG. 1B, the U-shaped knurl 14 has a first portion 18 that is substantially curved and a second portion 20 integrally formed with the first portion 18 and having two generally parallel sides. However, it is appreciated that the first portion 18 need not be substantially curved. For example, instead of stamping a U-shaped knurl 14, the deforming tool 16 may stamp a knurl having a different shape. In one exemplary approach, the first portion may be substantially straight (not shown). Moreover, the second portion 20 need not have two generally parallel sides. For example, it is appreciated that the second portion 20 may have two sides that are at angles relative to one another and/or the first portion 18.

Once deformed, in one exemplary approach, the first portion 18 is wider than the second portion 20, and the sides of the second portion 20 are no longer substantially parallel. To do this, as illustrated in FIG. 1C, the deforming tool 16 includes two substantially V-shaped knurls 22 that deform the terminal 10 on opposite sides of the substantially U-shaped knurl 14. As with the U-shaped knurl 14, deforming the terminal 10 with the V-shaped knurls 22 may include punching, embossing, stamping, impressing, etc. As illustrated in FIG. 1D, the V-shaped knurls 22 displace the second portion 20 and make the second portion 20 narrower than the first portion 18. In one exemplary approach, the resulting knurl has a substantially omega-shaped cross-section.

The two substantially V-shaped knurls 22 may deform the terminal 10 simultaneously or in sequence by the deforming tool 16. It is to be appreciated that the U-shaped knurls 14 and V-shaped knurls 22 need only have a U-shaped or V-shaped cross-section or configuration from a side view. For example, the V-shaped knurl 22 may alternatively be pyramid-shaped. In fact, the U-shaped knurls 14 and V-shaped knurls 22 may have any configuration so long as the resulting knurl has the first portion 18 wider than the second portion 20.

Moreover, multiple knurls may be defined by the terminal 10. For example, as illustrated in FIG. 1A, a plurality of U-shaped knurls 14 are used to deform the terminal 10, and each has the first portion 18 and the second portion 20. Accordingly, deforming the second portion 20 includes, for example, stamping two substantially V-shaped knurls 22 into the terminal 10 on opposite sides of each of the substantially U-shaped knurls 14 such that each of the V-shaped knurls 22 displaces the second portions 20 of each U-shaped knurl 14 to make each of the second portions 20 narrower than each of the first portions 18. Accordingly, the terminal 10 defines a knurl pattern 26 integrally formed with the material 12, and each knurl in the knurl pattern 26 has a first portion 18 that is wider than a second portion 20. Thus, each knurl in the knurl pattern 26 may have a substantially omega-shaped cross-section.

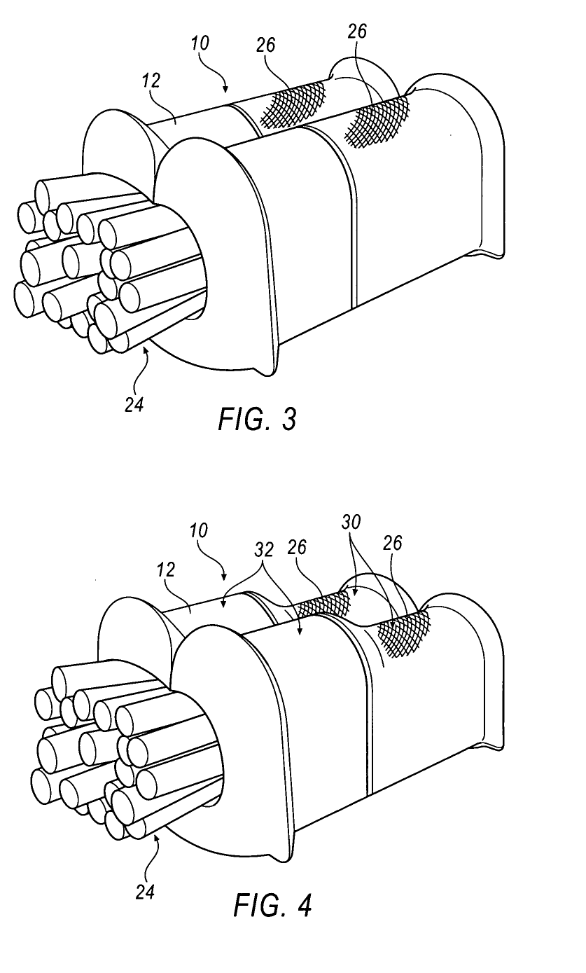

Referring to FIG. 2, the terminal 10 may be crimped to a wire 24 formed from a plurality of cable strands. The cable strands may be formed from various materials, including aluminum or aluminum-based materials. The knurl pattern 26 allows the terminal 10 to have a strong physical and electrical connection to the wire 24. To crimp the terminal 10 to the wire 24, the terminal 10 is bent to have generally U-shaped cross-section. In one exemplary approach, the terminal 10 includes integrally formed wings 28 extending from the material 12. The wire 24 is disposed onto the terminal 10, and the wings 28 are bent toward one another and folded inward. Then, the terminal 10 is squeezed together about the wire 24 until the terminal 10 and the wire 24 form a strong physical and electrical connection. FIG. 3 is an exemplary illustration of the terminal 10 crimped to the wire 24. In one exemplary approach, the wire 24 is formed form aluminum or an aluminum-based material.

Referring now to FIG. 4, the terminal 10 may be crimped in a two-stage crimp configuration. In this exemplary approach, the terminal 10 is deformed to form a first crimp 30 about the wire 24 and deformed again to form a second crimp 32 about the wire 24 adjacent to the first crimp 30. The first crimp 30 may be tighter against the wire 24 than the second crimp 32 such that the first crimp 30 maximizes electrical contact between the wire 24 and the terminal 10. However, because the first crimp 30 is tight against the wire 24, the first crimp 30 may reduce the pull-out force of the wire 24. This is especially true when the wire 24 is formed from aluminum or an aluminum-based material because a tight crimp on aluminum or aluminum-based wires 24 compresses the wire 24, which greatly reduces a surface area of the wire 24 relative to the terminal 10. Although the first crimp 30 increases the electrical connection between the wire 24 and the terminal 10, the reduced surface area as a result of the first crimp 30 reduces the mechanical or physical connection between the wire 24 and the terminal 10. Therefore, the second crimp 32 is not so tight against the wire 24 to greatly reduce the surface area of the wire 24. Although the electrical connection is not as strong as the first crimp 20, the second crimp 32 provides a stronger physical connection between the wire 24 and the terminal 10, and accordingly, maximizes the pull-out force of the wire 24 from the terminal 10.

The above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

The present embodiments have been particularly shown and described, which are merely illustrative of the best modes. It should be understood by those skilled in the art that various alternatives to the embodiments described herein may be employed in practicing the claims without departing from the spirit and scope as defined in the following claims. It is intended that the following claims define the scope of the invention and that the method and apparatus within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A cable comprising:
a wire; and
a terminal crimped onto said wire, and said terminal defining at least one knurl arrangement being integrally formed in the terminal, and each knurl arrangement comprising:
a first knurl element defined in the terminal to protrude from a surface of the terminal in a first direction, and the first knurl element further including a first portion remote from the surface and a second portion intermediate the surface and the first portion, and the first portion having a first width generally parallel to the surface and the second portion having a second width generally parallel to the surface; and
a plurality of second knurl elements defined in the terminal to protrude from the surface in the first direction about the first knurl element, and each second knurl element being spaced apart along the surface from the first knurl element, wherein said first width of the first portion is greater than the second width of the second portion after the plurality of second knurl elements are defined in the terminal;
wherein the crimped terminal includes the wire being in contact with at least a portion of the first portion of the first knurl element such that the wire is in mechanical and electrical connection with the terminal.

2-3. (canceled)

4. The cable as set forth in claim 1, wherein said terminal has a two-stage crimp configuration including a first crimp and a second crimp, and said first crimp contains the at least one knurl arrangement and the first crimp being crimped to the wire with a first crimp force and the second crimp being crimped to the wire with a second crimp force, said first crimp force being greater than said second crimp force such that the first crimp is held tighter against the wire than the second crimp.

5. The cable as set forth in claim 4, wherein said first crimp is adjacent to said second crimp.

6. The cable as set forth in claim 4, wherein said first crimp is configured to maximize electrical contact between said wire and said terminal.

7. The cable as set forth in claim 4, wherein said second crimp is configured to maximize a pull-out force of said wire from said terminal.

8. The cable as set forth in claim 26, wherein the material of the electrical conductor includes aluminum.

9. A method to crimp a terminal to a wire, comprising:
providing the wire:
providing the terminal formed of a material having a unitary configuration and a surface and configured to be crimped onto the wire;
deforming the material of the terminal to define at least one knurl arrangement in the terminal, said at least one knurl arrangement including a first knurl element and a plurality of second knurl elements, said first knurl element being defined in the terminal in a first direction and including a first portion and a second portion intermediate the first portion and a surface of the terminal, said first portion having a first width being generally parallel to the surface and a second width being generally parallel to the surface, and the plurality of second knurl elements being defined in the terminal in the first direction and spaced apart from the first knurl element such that after the plurality of second knurl elements are defined in the terminal the first width of the first portion is greater than the second width of the second;
inserting the wire into the terminal; and
crimping the terminal to the wire such that the terminal is configured about the wire so at least a portion of the first portion of the first knurl element makes electrical and mechanical contact with the wire.

10. The method as set forth in claim 9, wherein the step of deforming the material to define the at least one knurl arrangement further includes the second knurl element being two second knurl elements, and the two second knurl elements each have a V-shaped cross-section, and one of the second knurl elements is opposed to the other second knurl element about the first knurl element, and the first knurl element having a generally U-shaped cross-section before the two knurl elements are defined in the terminal, and the first knurl element is further conformed to an omega-shaped cross section after the two second knurl elements are defined in the terminal knurl.

11. The method as set forth in claim 10, wherein the step of deforming the material to define the at least one knurl arrangement includes the two second knurl elements being defined in the terminal in one of simultaneous and sequential order, and the two second knurl elements each comprise a cross-section V-shape.

12. The method as set forth in claim 9, wherein the step of deforming the material to define the at least one knurl arrangement further includes the first knurl element having an omega-shaped cross-section.

13-17. (canceled)

18. The method as set forth in claim 9, wherein the step of crimping the terminal onto the wire further includes the steps of:
configuring the terminal to form a first crimp about the wire; and
configuring the terminal to form a second crimp about the wire adjacent to the first crimp.

19. The method as set forth in claim 18, wherein the first crimp is made with a first crimp force and the second crimp is made with a second crimp force, and the first crimp force is greater than the second crimp force such that the first crimp is tighter against the wire than the second crimp and the first crimp maximizes electrical contact between the wire and the terminal and the second crimp maximizes a pull-out force of the wire from the terminal.

20. (canceled)

21. The terminal as set forth in claim 27, wherein at least a portion of the first portion of the first knurl element is configured to be in mechanical and electrical contact with said wire after the terminal is crimped to the wire.

22. (canceled)

23. The cable as set forth in claim 1, wherein each first knurl element comprises a cross-section being a generally U-shape when the first knurl element is defined in the terminal, and the second knurl element comprises a cross-section V-shape when the second knurl element is defined in the terminal, and the first knurl element further comprises being conformed to a cross-section omega shape after the second knurl element is defined in the terminal.

24. The cable as set forth in claim 1, wherein the first knurl element has a first height with respect to the surface of the terminal and the plurality of second knurl elements have a second height with respect to the surface of the terminal, said first height being greater than said second height.

25. The cable as set forth in claim 1, wherein the plurality of second knurl elements comprises two second knurl elements such that one second knurl element is disposed opposite from the other second knurl element about the first knurl element.

26. The cable as set forth in claim 1, wherein the terminal is formed of a material having a first hardness and an electrical conductor of the wire is formed of a material having a second hardness, and the first hardness is greater than said second hardness such that a crimp force crimps the wire to the terminal, and the application of the crimp force applies a pressure that configures the wire onto the at least one knurl arrangement such that the material of the wire deforms to conform to the first portion and the second portion of the first knurl element and the plurality of second knurl elements, and the first portion and the second portion of the first knurl element and the plurality of second knurl elements of the at least one knurl arrangement make contact with the wire such that the wire is in mechanical and electrical connection with the terminal, wherein the at least one knurl arrangement is a securing mechanism for the electrical conductor of the wire to the terminal.

27. A terminal comprising:
a material having a unitary configuration and a surface and configured to be crimped onto a wire; and
at least one knurl arrangement being integrally formed in said material and the at least one knurl arrangement comprising:
a first knurl element defined in the terminal and protruding from a surface of the terminal in a first direction, and the first knurl element further including a first portion remote from the surface and a second portion intermediate the surface and the first portion, and the first portion having a first width generally parallel to the surface and the second portion having a second width generally parallel to the surface; and
a plurality of second knurl elements defined in the terminal protruding from the surface in the first direction about the first knurl element, and each second knurl element being spaced apart from the first knurl element on the surface, wherein said first width of the first portion is greater than the second width of the second portion after the plurality of second knurl elements are defined in the terminal.

28. The terminal as set forth in claim 27, wherein the first knurl element has a first height with respect to the surface of the terminal and the plurality of second knurl elements have a second height with respect to the surface of the terminal, said first height being greater than said second height.

29. The terminal as set forth in claim 27, wherein the plurality of second knurl elements comprises two second knurl elements such that one second knurl element is disposed opposite to the other second knurl element about the first knurl element.

30. The terminal as set forth in claim 27, wherein each first knurl element comprises a cross-section being a generally U-shape when the first knurl element is defined in the terminal, and the second knurl element comprises a cross-section V-shape when the second knurl element is defined in the terminal, and the first knurl element further comprises being conformed to a cross-section omega shape after the second knurl element is defined in the terminal.

31. The method as set forth in claim 9, wherein the crimping the terminal to the wire step further includes the steps of:
breaking-up corrosion formed on the surface of the at least one knurl arrangement of the terminal during the crimping step as an electrical conductor is forced into the at least one knurl arrangement; and
clearing the corrosion from the surface of the at least one knurl arrangement of the terminal during the crimping step as the electrical conductor is forced into the that at least one knurl arrangement;
wherein an un-corroded portion of the electrical conductor of the wire is in mechanical and electrical connection with an un-corroded portion of the at least one knurl arrangement upon completion of the crimping step.

32. The method as set forth in claim 9, wherein the steps of providing the wire and providing the terminal further include the material of the terminal having a first hardness and an electrical conductor of the wire being formed of a material having a second hardness, and the first hardness is greater than said second hardness such that a crimp force crimps the wire to the terminal, and the application of the crimp force applies a pressure that configures the wire onto the at least one knurl arrangement such that the material of the wire deforms to conform to the first portion and the second portion of the first knurl element and the plurality of second knurl elements, and the first portion and the second portion of the first knurl element and the plurality of second knurl elements of the at least one knurl arrangement make contact with the wire such that the wire is in mechanical and electrical connection with the terminal, wherein the at least one knurl arrangement is a securing mechanism for the electrical conductor of the wire to the terminal.
